(19) United States
(12) Patent Application Publication
(10) Pub. No.: US 2003/0148908 A1
(43) Pub. Date: Aug. 7, 2003

(54) Detergent package

(76) Inventors: Jacques Michel, Kain (BE); Philippe Davenne, Estaimbourg (BE); Olivier Chevalier, Rumes (BE)

Correspondence Address: Woodard, Emhardt, Naughton,, Moriarty and McNett, Bank One Center/Tower, 111 Monument Circle, Suite 3700, Indianapolis, IN, 46204-5137, US

(21) Appl. No.: 10/016,816

(22) Filed: Dec. 11, 2001

(51) Int. Cl. C11D 17/00

(52) U.S. Cl. 510/296; 510/297; 510/481; 510/499

(57) ABSTRACT

A detergent package for immersion and dissolution in water (e.g. for laundry wash use) comprises a substantially anhydrous isotropic liquid detergent formulation encapsulating in water soluble film based on polyvinyl alcohol. The detergent formulation comprises an anionic surface active agent and a soap both dissolved in a liquid carrier. The formulation provides good water solubility, good detergency, high water softening power and compatability with the water soluble film.

The present invention relates to a detergent package comprised of a substantially anhydrous isotropic liquid detergent formulation packaged in a water soluble film particularly suitable for use in hand washing and delicate article washing wherein high foam levels are required.

The encapsulation of detergents in water soluble wrappings to form a convenient metered unit dose (i.e. sufficient detergent formulation for a single washing operation) primarily for domestic use is well known (e.g. U.S. Pat. No. 3,277,009 (General Aniline), U.S. Pat. No. 3,892,905 (du Pont), EP-A-0 700 989, WO-A-98/30670, WO-A-92/20774). When such wrappings contain a liquid the liquid needs to be predominantly anhydrous so as to avoid dissolving the wrapping prematurely before it is contacted with the wash water (e.g. EP 339 707 (Unilever).

Suitable substantially non-aqueous liquid detergent compositions have been disclosed in the art. One technology as for example described in EP 339 707 utilises a high level of an alcohol ethoxylate surfactant in conjunction with a solid suspension of water softener. Such compositions typically provide low foaming, particularly when used with the grades of non-ionic surfactants which readily dissolve from an anhydrous state, particularly in conjunction with suspended solids. High foaming readily soluble products are best obtained using anionic surfactants and low levels of suspended solids.

U.S. Pat. No. 3,528,925 (Chapuis) discloses an isotropic laundry liquid encapsulated in a gelatine or in a polyvinyl alcohol (PVA) film. However, some of the components of the liquid formulation have to be distilled in benzene in order to create compatibility between the film and the liquid.

GB 2 192 404 (Scherer) describes an encapsulated composition with 40 to 60% anionic surfactant as an amine salt of an alkyl ether sulphate and 25 to 35% of a low molecular weight polyethylene glycol. The latter component is essentially an inert solvent having nominal wash benefits whilst the lack of any water softening component requires the use of an ether sulphate to avoid precipitating the surfactant in hard water. Similarly U.S. Pat. No. 3,528,925 provides 33 to 65% of an anionic surface active agent but is also unbuilt i.e. devoid of water softener.

The art therefore does not teach a method of providing a readily soluble, high foaming, built isotropic liquid detergent formulation which is suitable for use in conjunction in a water soluble film package.

It is the object of the present invention to overcome the aforementioned disadvantages.

According to the present invention there is provided a detergent package comprised of a substantially anhydrous isotropic liquid detergent formulation packaged in a water soluble film material based on poly vinyl alcohol characterised in that the liquid detergent formulation comprises a soap, an anionic surface active agent other than a soap and a solvent for the soap and the anionic surface active agent, said formulation optionally containing other surfactants and subsidiary components.

We have found that the detergent formulation as defined in the previous paragraph provides excellent inwash properties both in terms of foam generation and cleaning characteristics. The formulation provides good water solubility, high water softening power and compatibility with the film. The package is convenient to use since it needs only to be immersed in water to dissolve the outer packaging and release the detergent formulation. Furthermore the package and its contents are storage stable.

Isotropic Liquid Detergent Formulation

Anionic Surfactant

Preferably the detergent formulation comprises 10% to 50% by weight (of the formulation) of the anionic surface active agent (other than soap). The amount of anionic surface active agent may for example be 15% to 50%, more preferably 20% to 50%, and even more preferably 25% to 45%. Suitable anionic surfactants are alkyl aryl sulphonic acid salts, e.g. dodecyl-benzene sulphonic acid salts. The salt may be an alkali metal salt but is more preferably an amine salt particularly an alkanolamine salt, e.g. monoethanolamine. The ethanolamine salt of dodecyl-benzene sulphonic acid is preferred because of good solubility and washing performance properties. The amount of ethanolamine salts of dodecyl-benzene sulphonic acid is preferably 25 to 45% and most preferably 29%.

Soap

Preferably the amount of soap (or soap blend) in the detergent formulation is 15% to 50% by weight of the formulation. More preferably the amount of soap is 20% to 50% of the formulation, still more preferably the amount of soap is preferably 20 to 35% and most preferably 23%. Suitable soaps are for example, salts of palm kernel or coco types fatty acids or mixtures of vegetable fatty acids. Suitable palm kernel or coco type fatty acids have a iodine value from 0 to 25% and acid value about 250-260 mg KOH/g. Suitable mixtures of vegetable fatty acids have an iodine value from 90 to 140% and a acid value about 200 mg KOH/g. The cation of the soap may be an alkali metal but is more preferably an amine particularly an alkanolamine, e.g. monethanolamine. Preferred soaps are the ethanolamine salts of palm-kernel type fatty acids.

Solvent

The liquid detergent also contains a solvent carrier. The solvent may be for example be single solvent or a solvent mixture, e.g. a blend of glycols, glycol ethers, alcohols, amines and ethanolamines. Solvents may be added directly to the formulation or be derived from the other raw materials of the liquid detergent composition. Preferably the liquid detergent contains as little water coming from the raw materials as possible and furthermore no added water. The preferred liquid detergent composition of the invention contains less than 10%, more preferably less than 5% of water coming from raw materials and no added water. The preferred solvents are ethyl alcohol, propylene glycol and ethanolamine. The preferred liquid detergent composition contains no added water but 0 to 50% of propylene glycol, ethyl alcohol and ethanolamine.

Other Surfactants

The liquid detergent formulation may contain other surface active agents additional to the soap and the anionic surface active agent. If such an additional surface active agent is used it may be an amphoteric, non-ionic or cationic surface active agent.

If an amphoteric surface active agent is used it may be present in the formulation in an amount of 0.1 to 10% by weight, more preferably 0.5 to 5%, even more preferably 1 to 4% on the same basis.

The amphoteric surface active agent may be betaine surface active agent. Preferred betaines may be either of the formula (I) or (II).

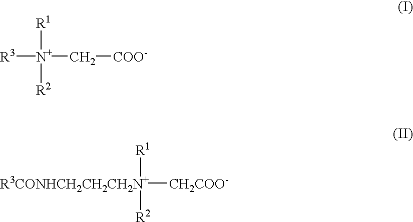

In the above formula, R1 and R2 may be the same or different C1-4 alkyl groups whereas R3 is an alkyl group having 8-22 carbon atoms, more preferably 12 to 18 carbon atoms e.g. mixed C10 to C14.

The preferred betaine for use is coco amidopropyl betaine.

An alternative amphoteric surface active agent for use in the formulation of the invention is a glycinate of the formula

R³NHCH₂CO₂H

where R3 is as defined above.

Other suitable materials are as given in chapter 1 of “Amphoteric Surfactants”, e.g. Lomax Ed, Marcel Decker, New York 1996.

The liquid detergent formulation preferably also contains an amount of 20 to 50% of a nonionic surfactant blend. Suitable nonionic surfactants are alcohol ethoxylates, amide ethoxylates, and alkyl polyglucosides; but alcohol ethoxylates blends are preferred. For example a blend of a condensed product of a C13/C15 synthetic alcohol with 3 moles of ethylene oxide and a condensed product of C13/C15 synthetic alcohol with 7 or 8 moles of ethylene is preferred. The liquid detergent contains preferably 20 to 35% of a nonionic surfactant blend and most preferably 21.6%. The most preferred liquid detergent contains 12.6% of a condensed product of C13/C15 fatty alcohol with 7/8 moles of ethylene oxide and 9.0% of a condensed product of a C13/C15 fatty alcohol with 3 moles of ethylene oxide.

If a cationic surface active agent is used it may be in an amount of up to 16% by weight of the formulation. Examples of suitable cationic surface active agents include quaternary ammonium salts having three lower (C1-4) alkyl groups (preferably methyl groups) and a long chain (C8-20) alkyl group, e.g. coco trimethyl ammonium chloride. Further examples include alkyl pyridinium salts and other compounds in which the nitrogen atom of the pyridine assumes a quaternary form, e.g. as in an alkyl pyridinium bromide. Cationics with C10 to C20, more preferably with, C12 to C18 alkyl chains are preferred.

Further examples of cationic surface active agents which may be used include amine and imidazoline salts.

Other Components

The liquid detergent also contains detergency aids like liquid detergent enzymes, phosphonates or other builders soluble in the said composition. The preferred compositions contains a protease enzyme which is of the Alcalase type as for example Alcalase 2.5 L or of the Savinase type as Savinase 16 Ldex; both from Novo Nordisk. The most preferred enzyme is the Savinase 16 Ldex because of its high purity and better solubility in low water contain detergent composition. The preferred composition contains about 0.1 to 5.0% of such an enzyme. The preferred phosphonates are for example of the Dequest type from Solutia and the preferred composition contains 0.1 to 6.0% of Dequest 2066. The liquid detergent may also contain some specific ingredients as for examples dyes fixatives, dyes transfer inhibition agents, softeners, soil release polymer, cellulase type enzyme, fluorescent whitening agent, solubilisers or hydrotropic agent and enzymes stability enhancers and the like.

The liquid detergent formulation may also contain some minor ingredients such as dyesopacifiers, pearlising agents, rheological modifiers, fragrances, denathonium benzoate, foam regulator, disinfectant, bactericidal agent and the like.

Polymeric Components

A number of polymeric components will typically be considered for use in the formulation of the invention.

A variety of water soluble polymers may be added to perform variety of functions, for example as thickeners and anti scaling agents.

Suitable polymers include, Addition polymers—e.g. Poly Vinyl; ethers, esters, amides, carboxylates, maleates, methacrylates, acrylates, alcohols, acetates, sulphonated polymers and amphoteric polymers and copolymers thereof. In particular block copolymers, homo polymer and copolymer prepared using vinyl carboxylates in combination with monomer selected from the group consisting of (meth)acrylonitrile, 2-trimethyl-siloxyethyl (meth)acrylate, 2-ethylhexyl (meth)acrylate, 2-ethoxyethyl (meth)acrylate, sorbyl (meth)acrylate, butyl (meth)acrylate, ethyl (meth)acrylate, glycidyl (meth)acrylate, hexyl (meth)acrylate, hexyl (meth)acrylate, hydroxyethyl (meth)acrylate, hydroxypropyl (meth)acrylate, (meth)acrylonitrile, lauryl (meth)acrylate, methyl (meth)acrylate, octyl (meth)acrylate, p-tolyl (meth)acrylate, phenyl (meth)acrylate, propyl (meth)acrylate, sorbyl (meth)acrylate, and stearyl (meth)acrylate, may be used. Homo and block polymers of the above monomers are particularly suitable for use in the invention.

Other suitable polymers include condensation polymers—e.g. Poly ; esters, and urethanes, gelatine, Carrageen, Gum Arabic (e.g. grade NF FCC ex Sarcom Inc.), Agar (e.g. Agar-Agar NF FCC Gel 10 ex Sarcom Inc), Guar Gum ( e.g. Powder HV-101 NF FCC ex Sarcom Inc), Locust Bean Gum (e.g. SG-14 FCC ex Sarcom Inc), Ghatti Gum (e.g. #1 FCC ex Sarcom Inc), Karaya Gum (e.g. #1 FCC ex Sarcom Inc), Karaya Gum (e.g. #1 FCC ex Sarcom Inc), Xanthan Gums (e.g. XAN-90 NF FCC ex Sarcom Inc.) and alginates.

Particularly preferred polymers are the Chitins, Chitosan and derivatives for their synergistic potentiation of antibacterial efficacy in combination with organic bactericides

Preferred molecular weights are from 5,000 to 100,000. More preferably from 10,000 to 30,000.

Suitable polymeric materials known in the art are Hydrogenated caster oils (e.g. Croduret 50 ex Croda), acrylic acid polymers (e.g. ex National Starch) Acrylate maleate polymers (e.g. Sokolan CP-5 and CP-10 ex BASF) and poly ethylene glycols (e.g. ex Hoechst), poly vinyl pyrrolidone (e.g. K50 ex ISP), Carbopol (ex 3V). Suitable levels of polymer inclusion are between 0.1 to 10% more preferably between 0.2 and 2% most preferably between 0.3 and 1.2%.

A variety of substantially water insoluble polymers may be added to perform a variety of functions for example soil release agents.,e.g. polyoxyethylene terephthalate, polyethylene terephthalate and cellulose and its hydroxy alkyl and carboxy alkyl derivatives. Such materials when incorporated in liquid compositions within the scope of the invention are preferably used with a particle size of from 0.1 to 50 μm, more preferably from 1 to 10 μm.

Bleaches

A bleaching composition may also be included. The preferred bleaching system for use in the invention comprises a hydrogen peroxide and a peracid precursor compound, preferably glycerol tri acetate or a pre formed peracid.

Specific examples of pre-formed per acid bleaches which may be used in the detergent formulations of the invention include phthalimido peroxihexanoic acid e.g. Eureco (TM) ex Ausimont) and diphthaloyl peroxide.

Specific examples of bleach activators which may be used in the detergent formulations of the invention include tetra alkyl alkylene diamines, particularly tetra acetyl ethylene diamine, glycerol tri alkylates, particularly glycerol triacetate, hexa acetyl sorbitol, hexa acetyl mannitol, penta acetyl glucose and octa acetyl sucrose. Particularly preferred are hexa acetyl sorbitol and hexa acetyl mannitol which may be used in admixture, e.g. as disclosed in EP-A-0 525 239. Further examples are compounds having nitrogen atoms in the basic carbohydrate skeleton, e.g. the peracetylated forms of N-methyl gluxconamide, N-methyl glucamine and glucopyronosyl amine.

It is considered particularly preferable to combine such bleach activators and such pre-formed per acids with one another to promote antibacterial and bleachable stain and soils cleaning. Particularly preferred combinations are of per acetic acid precursors with precursors of higher alkyl peracids such as fall in the range propyl to behenate. Particularly preferred are the branched alkyl analogues of such materials.

Such activators may be preferentially provided as a separate encapsulated component, by for example coating with a film forming polymer. Suitable film forming polymers include acrylates, methacrylates, celluloses, starches and their derivatives. Alternatively in solid products separate granules may be provided so as to enhance physical separation of the bleach source from the undissolved activator during storage.

Chlorine bleaches may also be employed either as a hypochlorite, for example, an alkali metal hypochlorite or as a precursor compound.

Physical Form of the Liquid

The detergent formulation encapsulated in the poly vinyl alcohol film is an isotropic liquid. For the purposes of the present invention, such a liquid is defined as one which (apart from any suspended material, e.g. beads, speckles or bubbles etc, added for the purpose of decoration) contains less than 5% by weight suspended matter at 25° C. The amount of suspended matter may be detected by centrifugation at a force of approximately 100 g for 15 minutes.

As indicated, additional suspended material may be incorporated for the purposes of decoration.

The Water Soluble Film

The packaging material will be comprised of a single material, in which case the hydrophilic layer most preferably comprises poly vinyl alcohol.

Poly vinyl alcohol, a polyhydroxy polymer having a polyethylene backbone with pendent hydroxy groups, is commonly produced by the hydrolysis of the respective poly vinyl acetate. It is preferred that poly vinyl alcohol is in the form of partially hydrolysed poly vinyl acetate or similar in which the poly vinyl alcohol is derived from polyvinyl alkylate ester subjected to between 70% and 95% hydrolysis.

Preferably the level of hydrolysis is between 80% to 90%, more preferably between 83% to 89%, and most preferably between 87% to 89%. These compositions have been found to provide a high degree of chemical stability.

The poly vinyl alcohol preferably has a number average molecular mass of between 20,000 to 200,000.

The preferred poly vinyl alcohol film is M8630 (ex Crist Craft) due to its quick dissolution property. Preferably the poly vinyl alcohol film has a thickness of 50 μm for the film gives the best compromise between roughness, quick dissolution and good storage stability.

The invention is illustrated using the following non limiting Examples.

### EXAMPLE 1

A liquid detergent formulation was prepared form the following components:

| | |
|---|---|
| Propylene glycol | QSP 100% |
| C13/C15 fatty alcohol with 7 EO | 12.600 |
| C13/C15 fatty alcohol with 3 EO | 9.000 |
| Monoethanolamine | 9.600 |
| Dodecyl benzene sulphonic acid 97% | 25.200 |
| Fatty acids blend | 18.000 |
| Denaturated ethyl alcohol 94% | 4.260 |
| Protease enzyme | 2.000 |
| Sodium phosphonate | 3.500 |
| O.B.A. | 0.500 |
| Denathonium benzoate 2.5%. | 0.010 |
| Dye C.I. 42051 blue | QS |
| Fragrance | QS |

PH (as is):8.6-8.6

Viscosity (Brookfoed LF, Spindle 2, Speed 30rpm):#300 mPas.

% water: ca 4.7%.

Detergent pouches were prepared by encapsulating 50 ml samples of the above formulation in polyvinyl alcohol films of 50 μm thickness. The polyvinyl alcohol films used were M7061, M8630 and M95000 ex Crist Craft).

The solubility of the pouches was evaluated using the following method: One pouch was attached above a beaker filled with 500 ml of deionised water. A magnetic stirrer was used to develop a vortex one-fifth the height of the column of water in the beaker. The pouch was then immersed in the water in the beaker. The determination of the solubility of the pouches was performed on freshly prepared samples, on samples that had been left at room temperature for various periods of time and on samples that had been subjected to accelerated ageing conditions(38° C., 80% RH) again for various periods of time. The time needed for the film to break is the disintegration time and the time needed for the film totally to dissolve is the dissolution time. The results were as follows:

| | Disintegration (sec)/Dissolution (sec) | | |
|---|---|---|---|
| Ageing conditions | M7061 | M8630 | M9500 |
| Fresh sample | 12/27 | 10/22 | 12/32 |
| 14 days @ RT | 18/39 | 14/29 | 15/32 |
| 28 days @ RT | 14/35 | 13/24 | 15/34 |
| 42 days @ RT | 17/33 | 13/28 | 17/34 |
| 14 days @ 38° C., 80% RH | 16/32 | 18/34 | 18/36 |
| 28 days @ 38° C., 80% RH | 17/34 | 17/37 | 18/35 |
| 42 days @ 38° C., 80% RH | 17/35 | 18/37 | 18/37 |

The fastest disintegration and dissolution times were obtained with the M8630 film when stored at R.T.

Infra spectra of the films which encapsulate the liquid were recorded before and after the ageing procedure of the pouches. No changes in the carbonyl structure were observed with the M7061 film. The carbonyl structure of the M9500 film was damaged after the ageing procedures. The carbonyl to carboxylate ratio within M8630 film, responsible for the maintenance of the solubility remained within the acceptable range. Plasticiser level determination showed that a maximum reduction of 59% in M7061; 71% in M9500, and 40% in M8630. No additional chemical structure modifications were observed. Thus, due to the high compatibility of the M8630 film the M8630 film is the preferred film for our invention.

Characteristics of this preferred film and suitable alternatives are tabulated below and have thickness' from 20 μm to 100 μm:

| | | M7061 | M8630 | M9500 |
|---|---|---|---|---|
| Typical Physical Properties at | | 21° C. and | 23° C. and | 23° C. and |
| | | 50% RH | 50% RH | 50% RH |
| Tensile strength | ASTMD882, | 5110 psi | 4000 psi | 5900 psi |
| | ISO 527 | | | |
| Modulus, 100% | ASTMD882, | 1278 psi | 1500 psi | 2000 psi |
| | ISO 527 | | | |
| % Elongation | ASTMD882, | 439% | 465% | 420% |
| | ISO 527 | | | |
| Tear resistance | ASTMD1922, | 1244 g/ml | 1050 g/ml | 1400 g/ml |
| | ISO 6383 | | | |
| Impact Strength | ASTMD1709, | 820 g | 800 g | 1000 g |
| | ISO 53443 | | | |

Equilibrium moisture content:

| | | | |
|---|---|---|---|
| At 50% RH | 8.6% | 6.9% | 6.4% |

Solubility 38 μm: disintegration

| | | | | |
|---|---|---|---|---|
| 10° C. Distilled | MSTM205 | 12 sec | 8 sec | 12 sec |
| water | | | | |
| 24° C. Distilled | MSTM205 | 7 sec | 4 sec | 7 sec |
| water | | | | |

Solubility 38 μm: dissolution

| | | | | |
|---|---|---|---|---|
| 10° C. Distilled | MSTM205 | 41 sec | 27 sec | 30 sec |
| water | | | | |
| 24° C. Distilled | MSTM205 | 28 sec | 17 sec | 18 sec |
| water | | | | |

Washing performances of the pouches were evaluated using pieces of selected standard test materials that were washed in Miele Novotronic W715 type machines programmed for short washing cycle without pre-wash, temperature of 40° C. and spin cycle at 1200 rpm. The washing machines also contained 17 kitchen towels as ballast. Three washing machines were used and the detergency (determined as below) recorded was averaged. The tests were also repeated using the liquid formulation added as such (i.e. not encapsulated in a poly vinyl alcohol film) and also a commercial liquid detergent. Dosage of the detergent was 100 ml for the liquid either added as such or as 2×50 ml pouches.

The detergency was calculated as described in “Surfactant in Consumer Products, Ed. By J. Fable, 1987, p217-218”. Reflectance was measured by means of a Minolta CM3600D spectrophotometer.

The test determined

a) primary detergency as a percentage on cotton and polyester cotton; and

b) washing performances on specific stains.

a) Primary detergency as a percentage on Cotton and Polycotton

| | Cotton cloth | | | | |
|---|---|---|---|---|---|
| | | | CFT | Polycotton cloth | |
| | WFK 10C | Empa 101 | AS9 | WFK 30C | Empa 104 |
| Commercial | 37.8 | 38.4 | 33.9 | 35.6 | 38.1 |
| liquid detergent | | | | | |
| Liquid detergent | 35.8 | 41.9 | 33.2 | 38.7 | 47.3 |
| of the invention | | | | | |
| Pouches of the | 34.4 | 41.3 | 33.5 | 36.7 | 46.9 |
| invention | | | | | |

b) Washing performance on standard industry stain cloths

| | Enzymes sensitve stains | | | Oxidation | |
|---|---|---|---|---|---|
| | | Empa | CFT | sensitive stains | |
| | Empa 112 | 116 | AS 10 | WFK 20C | Empa 104 |
| Commercial liquid | 58.2 | 68.3 | 44.1 | 40.3 | 40.0 |
| detergent | | | | | |
| Liquid detergent of | 54.1 | 67.7 | 44.2 | 40.3 | 39.7 |
| the invention | | | | | |
| Pouches of the | 52.0 | 66.8 | 43.5 | 39.9 | 39.4 |
| invention | | | | | |

| | Greasy soil | | |
|---|---|---|---|
| | | | CFT |
| | Empa 141 | CFT cs 10 | CS 04 |
| Commercial liquid | 35.9 | 51.7 | 64.2 |
| detergent | | | |
| Liquid detergent of | 36.9 | 51.6 | 64.0 |
| the invention | | | |
| Pouches of the | 38.3 | 51.7 | 64.4 |
| invention | | | |

The pouches of the present invention exhibit good washing performance, equivalent to that of the unencapsulated product indicative of adequate solubility.

### EXAMPLE 2

The following liquid detergent formulation may be used in place of that of Example 1.

| Component | Weight % |
|---|---|
| Propylene glycol | 11.00 |
| Monoethanolamine | 0.36 |
| C₁₃/C₁₅ fatty alcohol with 7 EO | 20.0 |
| Dodecyl benzene sulphonic; MEA salt | 20.0 |
| Coconut Fatty acid; MEA salt | 35.0 |
| Denaturated ethyl alcohol 94% | 4.3 |
| Sodium phosphonate | 6.0 |
| Protease enzyme (Savinase) | 2.0 |
| Optical Brightening Agent | 0.4 |
| Denathonium benzoate 2.5%. | 0.4 |
| Foam Depressor | 0.05 |
| Blue dye C.I. 42051 blue | QS |
| Fragrance | QS |

pH (as is): 9.2-9.6

Viscosity (Brookfield LF spindle 2 speed 30 rpm): #300 mPas

% Water: around 6.3%

### EXAMPLE 3

The following liquid detergent formulation my be used in place of that of Example 1.

| Component | Weight % |
|---|---|
| Propylene glycol | 6.0 |
| C₁₃/C₁₅ fatty alcohol with 7 EO | 20.0 |
| Monoethanolamine | 0.80 |
| Dodecyl benzene sulphonic; MEA salt | 18.0 |
| Coconut Fatty acid; MEA salt | 40.0 |
| Denaturated ethyl alcohol 94% | 5.95 |
| Sodium phosphonate | 5.5 |
| Protease enzyme (Savinase) | 0.8 |
| Protease enzyme (Alcalase) | 2.0 |
| Optical Brightening Agent | 0.4 |
| Denathonium benzoate 2.5%. | 0.4 |
| Foam Depressor | 0.05 |
| Blue dye C.I. 42051 blue | QS |
| Fragrance | QS |

pH (as is): 8.8-9.2

Viscosity (Brookfield LF spindle 2 speed 30 rpm): #300 mPas

1) A detergent package comprised of a substantially anhydrous isotropic liquid detergent formulation packaged in a water soluble film material based on poly vinyl alcohol characterised in that the liquid detergent formulation comprises a soap, an anionic surface active agent other than a soap and a solvent for the soap and the anionic surface active agent, said formulation optionally containing other surfactants and subsidiary components.

2) A package according to claim 1 wherein the detergent formulation comprises 10% to 50% by weight (of the formulation) of the anionic surface active agent.

3) A package as claimed in claim 2 wherein the detergent formulation comprises 20% to 50% by weight (of the formulation) of the anionic surface active agent.

4) A package according to any one of claims 1 to 3wherein the anionic surfactant is an alkyl aryl sulphonate amine salt.

5) A composition according to claim 4 wherein the anionic surfactant is ethanolamine salt of dodecyl-benzene-sulphonic acid.

6) A package as claimed in any one of claims 1 to 5 wherein the detergent formulation comprises 15% to 50% by weight (of the formulation) of soap.

7) A package as claimed in claim 6 wherein the detergent formulation comprises 20% to 50% by weight of the soap.

8) A package as claimed in any one of claims 1 to 7 wherein the cation of the soap is derived from an amine.

9) A package as claimed in claim 8 wherein the cation of the soap is derived from ethanolamine.

10) A package as claimed in any one of claims 1 to 9 wherein the liquid detergent formulation contains 20% to 50% alcohol ethoxylate surfactant.

11) A package as claimed in any one of claims 1 to 10 wherein the solvent comprises ethyl alcohol, propylene glycol and/or ethanolamine.

12) A package as claimed in any one of claims 1 to 11 wherein the poly vinyl alcohol is derived from polyvinyl alkylate ester subjected to between 70% and 95% hydrolysis.
